(19) United States
(12) Patent Application Publication
(10) Pub. No.: US 2017/0197813 A1
(43) Pub. Date: Jul. 13, 2017

(54) BOTTLE CAP REMOVAL TOOL

(71) Applicant: Kevin Boldiszar, Royal Oak, MI (US)

(72) Inventor: Kevin Boldiszar, Royal Oak, MI (US)

(21) Appl. No.: 15/400,019

(22) Filed: Jan. 6, 2017

Related U.S. Application Data
(60) Provisional application No. 62/275,848, filed on Jan. 7, 2016.

(51) Int. Cl. B67B 7/16; B67B 7/18

(52) U.S. Cl. CPC B67B 7/16; B67B 7/18

(57) ABSTRACT

A disclosed bottle cap removal tool provides for removal of a bottle cap without damage to the bottle cap. Removal of a bottle cap without damage is useful for collectors and crafters. The disclosed bottle cap removal tool includes a cavity within ae housing with an open front end for receiving a bottle cap secured to a bottle. A lip extends inward into the cavity for engaging a bottom edge portion of a bottle cap. The lip contacts a sufficient portion of the bottom edge of the bottle cap to enable removal of the cap with a slight upward movement of the housing.

### CROSS REFERENCE TO RELATED APPLICATIONS

This application claims priority to U.S. Provisional Application No. 62/275,848 filed Jan. 7, 2016.

### BACKGROUND

This disclosure generally relates to a tool for removing a cap from a bottle. More particularly, this disclosure relates to a tool for removing a cap from a bottle without damage to the bottle cap while also holding the cap.

Craft beers are increasing in popularity and expanding the selection and style of beer available for consumption. Each of the craft beers and different craft breweries have unique artwork for the bottles, packaging and bottle caps. The bottle caps are not an item that is typically recycled but includes unique artwork that has generated a new genre for collectors and crafty minded people. Many will create collections for the different bottle caps, or create displays utilizing bottle caps with unique artwork.

Typical bottle cap removal tools result in destruction, or at the very least bending of the bottle cap. Bending or other deformation of the bottle cap reduces the desirability for use as part of a unique artwork or inclusion as part of a collection.

### SUMMARY

A disclosed bottle cap removal tool includes a housing defining a front face and a length. A cavity within the housing is open at a front end and extends from the front face to a back surface. The bottom surface of the cavity is open. A front face of the housing is open for receiving a bottle cap secured to a bottle. A lip extends inward into the cavity for engaging a bottom edge portion of a bottle cap. The lip contacts a sufficient portion of the bottom edge of the bottle cap to enable removal of the cap with a slight upward movement of the housing. The lip may be an integral or separate part of the removal tool and defines a depth within the cavity for receiving a bottle cap.

The disclosed bottle cap removal tool provides for the removal of bottle caps without the need of excessive force in such a matter so as to prevent damage to the removed bottle cap. Removal without damage a bottle cap is desirable to collectors and crafters.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic representation of a cap removal tool according to an example embodiment of this disclosure.

FIG. 2 is a bottom view of a cap within the cap removal tool.

FIG. 3 is a bottom view of the cap removal tool.

FIG. 4 is a cross-sectional view of the cap removal tool.

FIG. 5 is a front view of the cap removal tool.

FIG. 6 is bottom view of another cap removal tool.

FIG. 7 is front view of the cap removal tool shown in FIG. 6.

FIG. 8 is a schematic view of a cap removal tool mounted to a fixed structure.

FIG. 9 is a side view of another cap removal tool.

FIG. 10 is a side view of another cap removal tool including a channel for removed bottle caps.

### DETAILED DESCRIPTION

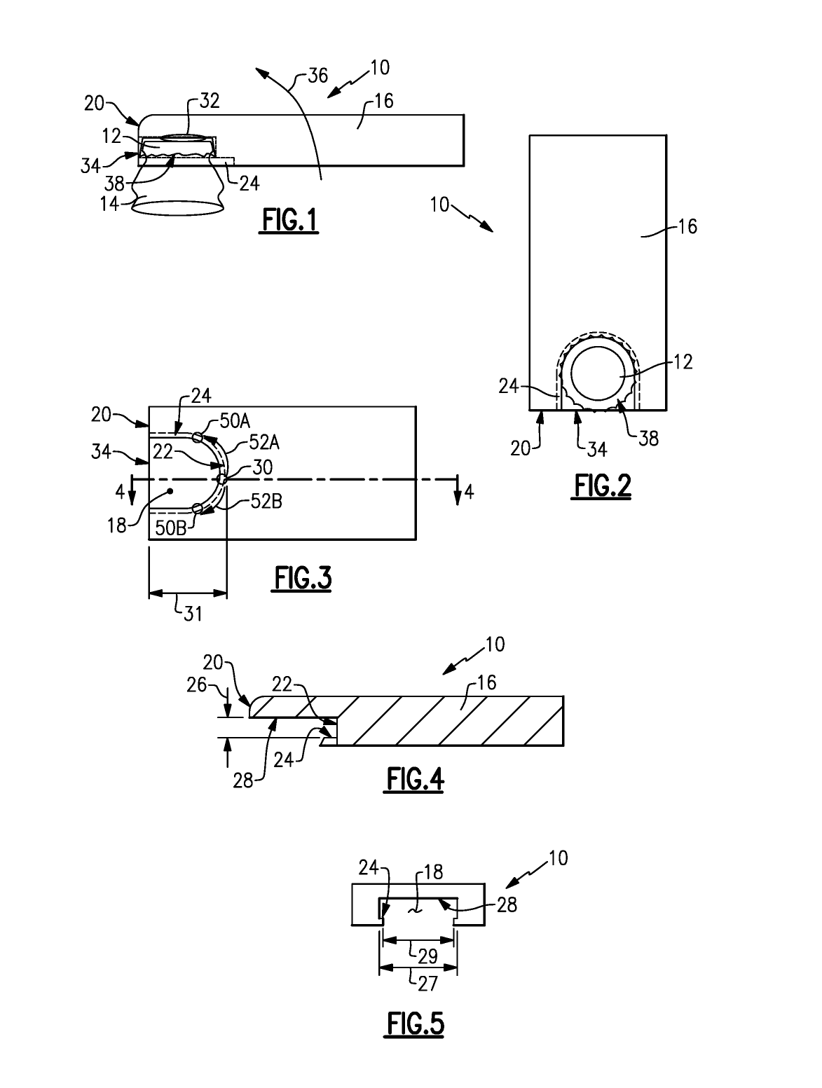

Referring to FIGS. 1, 2 and 3, an example removal tool 10 is schematically shown and includes a cavity 18 for receiving a bottle cap 12 installed to a bottle 14. In this example, the cap 12 is crimped to on to the bottle 14 and not provided as a twist-off version. It should be understood that it is within the contemplation of this disclosure that the example tool 10 could be utilized to remove a twist-off cap 12. The example tool 10 is utilized to remove the cap 12 without bending, deforming or otherwise damaging the cap 12. The example tool 10 also holds the cap 12 once removed to enable easy retrieval and prevent potential damage caused by the cap 12 falling away from the bottle 14. The cap 12 is held without the need for a magnet or other clip.

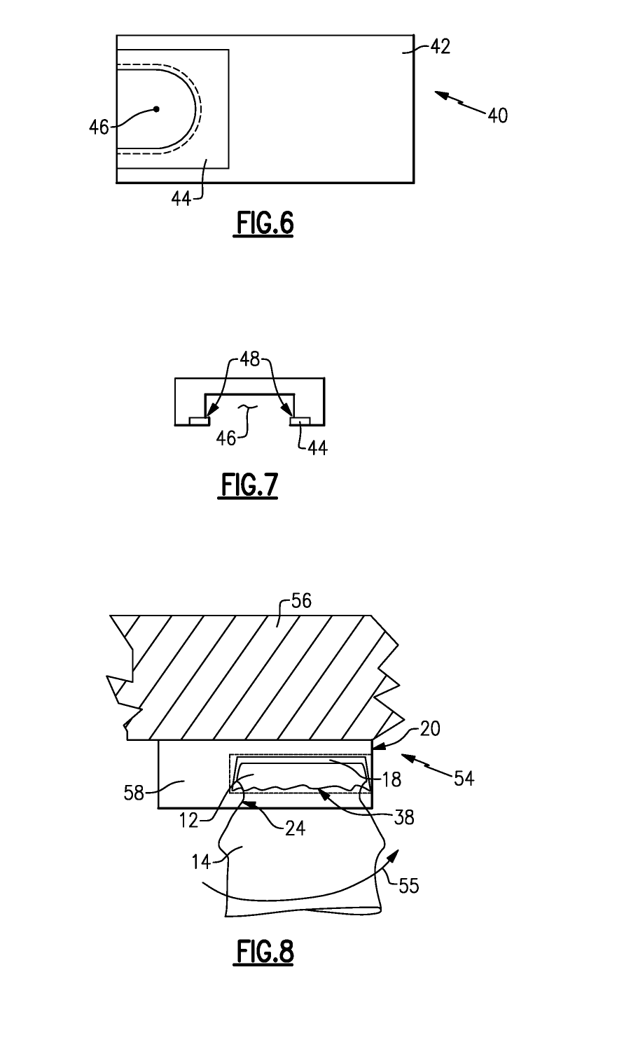

Referring to FIGS. 4-5 with continued reference to FIGS. 1-3, the example cap removal tool 10 includes a lip 24 that projects inward into the cavity 18 around a periphery of the cavity 18. The cavity 18 includes an opening 34 at a front face 20 for receiving the cap 12 when still installed to the bottle 14. In other words, the example tool 10 includes the cavity 18 that receives the cap 12 while still on the bottle 14. The lip 24 extending into the cavity 18 functions to remove the cap 12 and also to hold the cap 12 within the cavity 18 once free of the bottle 14.

The cavity 18 includes a depth 26 (FIG. 4) from the lip 24 to a bottom surface 28 of the cavity 18. In this example, the bottom surface 28 is abutted against a top surface of the cap 12 along an interface 32 (FIG. 1). The lip 24 extending around the cavity 18 engages a bottom edge 38 of the cap 12 at a rear contact point indicated at 30. The lip 24 further engages the bottom edge 38 of the cap 12 at contact points 50A and 50B. Accordingly, the lip 24 provides at least three points of contact with the bottom edge 38 of the cap 12. It should be appreciated that the lip 24 may also comprise three separate points rather than a continuous structure. The back contact point 30 is at near the back surface 22. The other two contact points 50A and 50B are spaced apart from the contact point 30 toward the forward face 20. The spacing between the forward two contact points 50A and 50B and the rear contact point 30 is provided to support the cap within the cavity 18 once removed and also to generate the contact forces required to pry the cap 12 from the bottle 14 with minimal distortion.

Pivoting of the housing 16 as indicated by arrow 36 pries the cap 12 free from the bottle 14. The pivoting movement generates a lower contact interface that begins at the back contact point 30 and extends around the lip 24 toward the forward two contact points 50A and 50B. The lower interface extends in the direction indicated by arrows 52A and 52B until the cap 12 is free of the bottle 14. The top surface 28 of the cavity 18 engages the top surface of the cap 12.

The pivoting motion indicated at 36 applies a force to the cap 12 between the lip 24 and the surface 28 along a top interface 32. The applied forces on the edge of the cap 38 that extends from the rear contact point 30 toward the forward contact points 50A, 50B along the lower interface 52A, and 52B. The lower interface 52A, 52B is a line contact that extends forward until sufficient force is applied to release the cap 12 from the bottle 14. The length along the lip 24 that define the lower interface 52A, 52B will vary depending on the bottle cap 12 and the amount of force required to release the cap 12. In some instances, the lower interface 52A, 52B will extend only a small distance from the rear contact point 30. In other applications, forces will be applied over a longer distance around the lip 24.

In this example, the lip 24 extends about the entire periphery of the cavity 18 around the cap 12 such that the cap 12 remains within the cavity 18 once removed. Moreover, because the lip 24 extends around the entire periphery of the cavity 18, the lower interface 52A, 52B can extend the entire length of the lip 24. It should be appreciated that although the example lip 24 extends around the entire cavity 18, that the lip 24 could be shorter, or consist of several separate points determined to provide the forces needed to remove the cap 12 and hold the cap 12 once free of the bottle 14.

The cavity 18 substantially surrounds the cap 12 while installed onto the bottle. The example cavity 18 is sized to accept the size and shape of a common round bottle cap. In this example, the cavity 18 includes a first width 27 to accept the entire cap 12 and a second width 29 defined by the lip 24 to engage the bottom edge of the cap as is shown in FIGS. 1 and 2.

The lip 24 surrounding the cavity engages the bottom edge of the cap and with the schematically shown lifting motion indicated by arrow 36, enables the application of force to remove the cap 12. The removal forces are applied over the entire top surface of the cap 12 along with the points of contact on the lower edge such that the cap 12 may be removed without damaging or otherwise deforming the cap 12. Accordingly, the example tool 10 applies the force over a substantially larger area along the top of the cap to prevent such damage and distortion.

The example cap removal tool includes the cavity 18 that is extends from the forward face 20 inward a distance 31 (FIG. 3) that corresponds with a diameter or a typical bottle cap. The rear or back surface 22 of the cavity 18 is curved to match the curvature of a typical bottle cap. The entire surface of the cavity 18 from a first side at a front location to a second side at the front location includes the lip 24. The lip 24 engages a bottom edge 38 of the cap and allow for prying of the cap from the bottle 14.

The disclosed example tool 10 is of a one piece construction and includes an integrally formed lip 24. However, it is within the contemplation of this disclosure that the tool could be made of several different parts that are attached to provide the desired geometry.

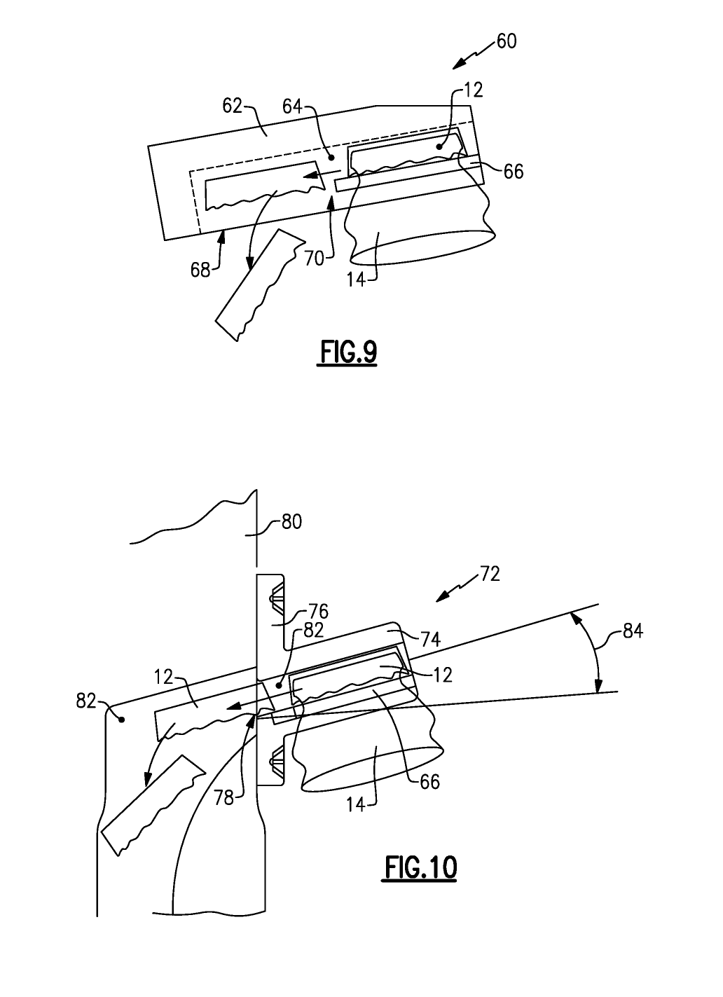

Referring to FIGS. 6 and 7, another example tool 40 includes an insert 44 attached to a housing 42. The insert 44 defines a lip 48 that is supported over a cavity 46. The example insert 44 defines the lip 48 and can be fabricated from a material different from the housing 42. In this example the housing 42 is made from wood and the insert is fabricated from metal. As appreciated, the housing 42 and insert could be fabricated from wood, plastic, steel or any other materials as are known in the art.

The example tools 10 and 40 each include the cavity 18 with the lip 24. The cavity 18 and lip 24 provided in the tools 10 and 40 can be defined within different mounting structures to accommodate different applications. The example tools 10 and 40 are provided for use as a hand tool, however, the cavity 18 and lip 24 could be mounted to a structure as is indicated at 54 in FIG. 8. The example tool 54 is mounted to a fixed structure such as the bottom surface of a countertop 56. The tool 54 includes a housing 58 that provides for mounting to the countertop 56. In the configuration shown in FIG. 8, the tool 54 is not pivoted. Instead, the cap 12 on the bottle 14 is inserted into the cavity 18 and the bottle 14 pivoted in the direction indicted by arrow 55 to apply the required forces to separate the cap 12 from the bottle 14.

Referring to FIG. 9, another cap removal tool 60 is shown and includes a housing 62 that includes a cavity 64 that extends past a lip 66. The housing 62 could be hand held or mounted to a fixed structure. The cavity 64 includes a bottom opening 68 past the lip 66 to enable a cap 12 to fall from the removal tool 60. The cap removal tool 60 can be mounted or hand held and includes the cavity 64 that is open at a back side 70 past the lip 66. The example tool 60 includes the lip 66 on sides of the cap 12 as discussed with regard to the above disclosed removal tools 10, 40 and 54, but does not include a lip that extends along a back side. In some uses, it may be beneficial to have the cap 12 self-release by sliding rearward and then through the bottom opening 68. Such a feature enables one handed removal of caps 12 while also readying the tool 60 for removal of a subsequent cap 12.

Referring to FIG. 10, a mountable cap removal tool 72 is shown that includes a mounting flange 76 that enables mounting to a fixed surface shown schematically at 80. The removal tool 72 includes a housing 74 that defines a cavity 82 with a back side opening 78 for release of the bottle cap 12. The back side opening 78 is in the removal tool 72 and corresponds with an opening 82 in the fixed surface 80. The cavity 82 includes a lip 66 that facilitates removal of the cap 12. The lip 66 of the removal tool 72 extends to the back of the cavity 82 to provide a surface for the cap 12 to slide out the back side opening 78.

The fixed surface 80 includes the opening 82 that enables release of the cap 12 into a receptacle or other catching device. The example cavity 82 is disposed at an upward angle 84 that provides for the cap 12 to slide from the cavity 82 and through the back side opening 78.

Accordingly, the example discloses cap removal tools 10, 40, 54, 60 and 72 enable removal of and capture of a bottle cap 12 from a bottle 14 without damage to the cap 12.

Although a preferred embodiment of this disclosure invention has been provided by way of example, a worker of ordinary skill in this art would recognize that certain modifications would come within the scope of this invention. For that reason, the following claims should be studied to determine the true scope and content of this invention.

What is claimed is:

1. A bottle cap removal tool comprising:
a housing defining a front face and a length;
a cavity open that extends from the front face to a back surface and is open through a bottom surface of the housing, the cavity open at the front face; and
a lip extending inward from into the cavity at the top surface for engaging a portion of a bottle cap.

2. The bottle cap removal tool as recited in claim 1, wherein the lip extends about a perimeter of the opening to the cavity on the bottom surface.

3. The bottle cap removal tool as recited in claim 1, wherein the cavity includes a top surface for engaging a top surface of a bottle cap.

4. The bottle cap removal tool as recited in claim 1, wherein the lip engages a bottom surface of the bottle cap proximate the back surface.

5. The bottle cap removal tool as recited in claim 1, wherein the lip is an integral part of the housing.

6. The bottle cap removal tool as recited in claim 1, wherein the lip is a separate part attached to the housing over the cavity.

7. The bottle cap removal tool as recited in claim 1, wherein the cavity includes an open back side through which the bottle cap may be removed.

8. The bottle cap removal tool as recited in claim 7, wherein the housing includes a flange for securement to a fixed surface and the open back side extends through the flange.

9. The bottle cap removal tool as recited in claim 7, wherein the cavity is angled relative upward such that the cap slides through the open back side.

10. The bottle cap removal tool as recited in claim 7, wherein the cavity includes a bottom opening rearward of the lip for releasing a cap from the cavity.

11. A bottle cap removal tool comprising
a housing defining a front face and a flange for securement to a fixed surface;
a cavity that extends from the front face and is open through a bottom surface of the housing, the cavity open at the front face; and
a lip extending inward into the cavity at the top surface for engaging a portion of a bottle cap.

12. The bottle cap removal tool as recited in claim 11, wherein the cavity includes a back opening rearward of the lip, the back opening enabling release of the cap from within the cavity.

13. The bottle cap removal tool as recited in claim 11, wherein the back opening is through a bottom surface rearward of the lip.

14. The bottle cap removal tool as recited in claim 11, wherein the back opening is through a back surface of the housing.

15. The bottle cap removal tool as recited in claim 11, wherein the lip is a separate part from the housing.

16. The bottle cap removal tool as recited in claim 12, wherein the lip and cavity are both angled upward such that the cap slides through the back opening.

17. The bottle cap removal tool as recited in claim 16, wherein the angle back opening corresponds with an opening in the fixed surface.

18. The bottle cap removal tool as recited in claim 11, wherein the cavity includes a depth between the lip and a top surface of the cavity that correspond with a thickness of the bottle cap.
